(19) United States
(12) Patent Application Publication
(10) Pub. No.: US 2005/0041199 A1
(43) Pub. Date: Feb. 24, 2005

(54) Device for adjusting length of sunshade clip for spectacles

(76) Inventor: Kwang Nam Kim, Daegu (KR)

Correspondence Address: ST. ONGE STEWARD JOHNSTON & REENS, LLC, 986 BEDFORD STREET, STAMFORD, CT, 06905-5619, US

(21) Appl. No.: 10/712,485

(22) Filed: Nov. 13, 2003

(30) Foreign Application Priority Data
Aug. 22, 2003 (KR) 2003-0027033

(51) Int. Cl. G02C 7/08

(52) U.S. Cl. 351/58

(57) ABSTRACT

Disclosed herein is a device for adjusting the length of a sunshade clip for spectacles which is capable of preventing not only penetration of moisture and other foreign matters into the device for adjusting the length of the sunshade clip for spectacles but also rotation of a bridge element when the device for adjusting the length of the sunshade clip for spectacles is operated. The sunshade clip comprises a pair of lens frames with corresponding colored lenses fitted therein, prongs formed at the outside of each frame, the prongs being vertically spaced apart from each other such that the prongs are fitted around a corresponding frame of the spectacles, bridge elements joined to the tops of the frames and extended from the tops of the frames, respectively, so that the bridge elements are connected between the frames, and a length adjusting device mounted between bridge elements for adjusting the length of the bridge elements. The length adjusting device comprises a cylindrical housing with a length sufficient for the sunshade clip to be easily engaged with the frames of the spectacles from the outsides of the frames of the spectacles, the housing having an inner wall formed longitudinally therein, caps attached to both sides of the housing, respectively, each of the caps having a through-hole for allowing the corresponding bridge element to move in and out therethrough, stoppers formed at the ends of the bridge elements, respectively, the ends of the stoppers being placed inside the housing, and coil springs disposed between the stoppers and the caps, respectively, for forcing the bridge elements towards each other. The inner wall of the housing and the stoppers together form rotation preventing units for preventing rotation of the bridge elements, respectively, when the bridge elements are moved.

This application claims priority from pending Korean Patent Application No. 2003-0027033 filed Aug. 22, 2003.

### FIELD OF THE INVENTION

The present invention relates to a device for adjusting the length of a sunshade clip for spectacles, and more particularly to a device for adjusting the length of a sunshade clip by which a sunshade clip used as a substitute for sunglasses is easily attached to or detached from general spectacles.

### DESCRIPTION OF THE RELATED ART

Recently, sunglasses have been increasingly used, which are generally used to intercept sunlight in the summer season having high intensity of direct light and ultraviolet light. It is necessary, however, to additionally prepare such sunglasses aside from spectacles, and storage of the sunglasses is troublesome. Furthermore, the sunglasses must be manufactured with the same degrees as the lens of the spectacles in order that persons who wear spectacles can wear the sunglasses without their glasses. Consequently, a heavy burden may be imposed on the persons who wear spectacles, and use of the sunglasses with heavy lenses is considerably inconvenient.

To solve the aforesaid problems raised in the conventional sunglasses, there have been proposed various sunshade clips for persons who wear spectacles, each of which generally comprises lens frames with lenses fitted therein and detachably attached to spectacles.

The sunshade clips are basically classified into magnet-type sunshade clips which can be detachably attached to spectacles by using magnets mounted in lens frames of the spectacles and in the sunshade clips and length adjustment-type sunshade clips which can be detachably attached to spectacles by adjusting the length of bridge elements connected between lens frames of the sunshade clips.

A large number of length adjustment-type sunshade clips have been proposed. For example, one of the length adjustment-type sunshade clips is disclosed in U.S. Pat. No. 6,234,628, which will be hereinafter described with reference to FIG. 7.

As shown in FIG. 7, the length adjustment-type sunshade clip includes lens frames 2 and 3 with colored lenses 1 fitted therein. Each of the lens frames 2 and 3 has L-shaped prongs 4 formed at the outside thereof, which are vertically spaced apart from each other such that the prongs 4 are fitted around a corresponding frame of spectacles. The lens frames 2 and 3 also have bridge elements 5 and 6, respectively. The bridge elements 5 and 6 are joined to the tops of the frames 2 and 3, respectively, and extended from the tops of the frames 2 and 3, respectively, so that the bridge elements 5 and 6 are connected between the frames 2 and 3.

Between bridge elements 5 and 6 is mounted a length adjusting device 7 for adjusting the length of the bridge elements 5 and 6.

The length adjusting device 7 includes a cylindrical housing 9 having a space 8 defined therein. The cylindrical housing 9 is integrally attached to the bridge element 6. The bridge element 5 is inserted into the housing 9. To the end of the housing 9, through which the bridge element 5 is inserted, is attached a cap 10.

At the end of the bride element 5 placed in the housing 9 is formed a stopper 11. Between the cap 10 and the stopper 11 is arranged a coil spring 12, which forces the bridge element 5 towards the bridge element 6 so that the prongs 4 are securely fitted around the frames of the spectacles after the length of the bridge elements 5 and 6 is adjusted.

At one side of the stopper 11 is formed a protrusion 13, which is engaged in a slot 14 formed in the housing 9 for preventing rotation of the bridge element 5.

As described above, the slot 14 is formed in the housing 9 in such a manner that the protrusion 13 of the stopper 11 can be fully reciprocated along the slot 14 for preventing rotation of the bridge element 5 while the length of the bridge elements 5 and 6 is adjusted. As a result, hair of a user of the sunshade clip may be caught between the protrusion 13 of the stopper 11 and the slot 14 if the user has long hair, which causes the user inconvenience.

Furthermore, sweat of the user or other moisture may gather in the slot 14, which causes the coil spring 12 to be corroded or damaged. As a result, smooth operation of the length adjusting device 7 ceases. Smooth operation of the length adjusting device 7 also ceases when foreign matter is filled in the slot 14 and thus the slot 14 is clogged. Consequently, users may suffer inconvenience in using the conventional device for adjusting the length of the sunshade clip for spectacles.

### SUMMARY OF THE INVENTION

Therefore, the present invention has been made in view of the above problems, and it is an object of the present invention to provide a device for adjusting the length of a sunshade clip for spectacles which is capable of preventing not only penetration of moisture and other foreign matters into the device for adjusting the length of the sunshade clip for spectacles but also rotation of a bridge element when the device for adjusting the length of the sunshade clip for spectacles is operated, thereby improving convenience for users and quality of the sunshade clip.

In accordance with the present invention, the above and other objects can be accomplished by the provision of a device for adjusting the length of a sunshade clip for spectacles, the sunshade clip comprising: a pair of lens frames with corresponding colored lenses fitted therein; prongs formed at the outside of each frame, the prongs being vertically spaced apart from each other such that the prongs are fitted around a corresponding frame of the spectacles; bridge elements joined to the tops of the frames and extended from the tops of the frames, respectively, so that the bridge elements are connected between the frames; and a length adjusting device mounted between bridge elements for adjusting the length of the bridge elements, wherein the length adjusting device comprises: a cylindrical housing with a length sufficient for the sunshade clip to be easily engaged with the frames of the spectacles from the outsides of the frames of the spectacles, the housing having an inner wall formed longitudinally therein; caps attached to both sides of the housing, respectively, each of the caps having a through-hole for allowing the corresponding bridge element to move in and out therethrough; stoppers formed at the ends of the bridge elements, respectively, the ends of the stoppers being placed inside the housing; and coil springs disposed between the stoppers and the caps, respectively, for forcing the bridge elements towards each other, the inner wall of the housing and the stoppers together forming rotation preventing units for preventing rotation of the bridge elements, respectively, when the bridge elements are moved.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing a sunshade clip for spectacles, to which a device for adjusting the length of a sunshade clip for spectacles according to a preferred embodiment of the present invention is applied;

FIG. 2 is a longitudinal sectional view of the device for adjusting the length of the sunshade clip for spectacles taken along the line A-A of FIG. 1;

FIG. 3 is a cross sectional view of the device for adjusting the length of the sunshade clip for spectacles taken along the line B-B of FIG. 2;

FIGS. 4A and 4B are similar to FIG. 3, each of which shows, in cross section, a device for adjusting the length of a sunshade clip for spectacles according to another preferred embodiment of the present invention;

FIG. 5 is an enlarged perspective view, partially broken away, showing the C portion of the device for adjusting the length of the sunshade clip for spectacles of FIG. 2;

FIG. 6 is a longitudinal sectional view of a device for adjusting the length of a sunshade clip for spectacles according to still another preferred embodiment of the present invention;

FIG. 7 is a front view showing a sunshade clip for spectacles, to which a conventional device for adjusting the length of a sunshade clip for spectacles is applied; and

FIG. 7A is a longitudinal sectional view showing the device for adjusting the length of the sunshade clip for spectacles of FIG. 7.

### DESCRIPTION OF PREFERRED EMBODIMENTS

Now, preferred embodiments of the present invention will be described in detail with reference to the accompanying drawings.

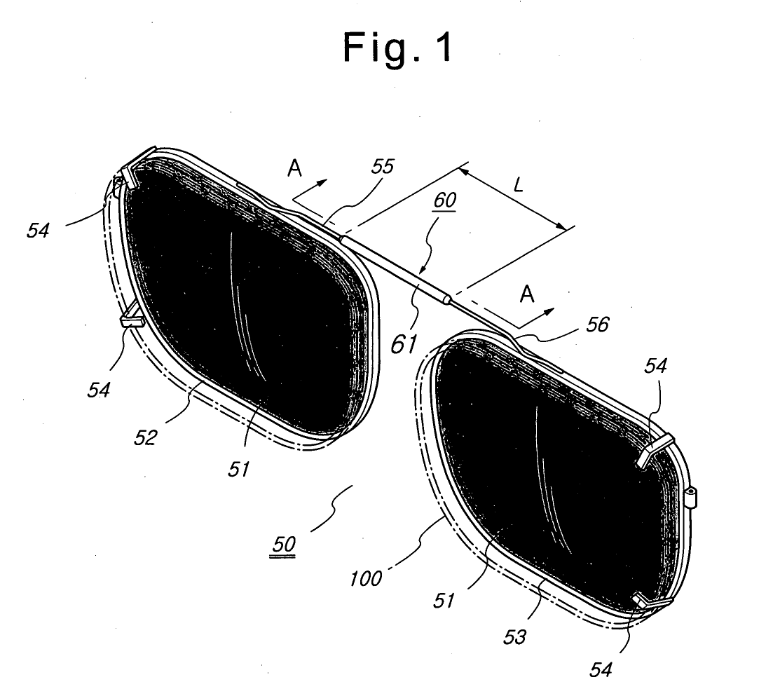

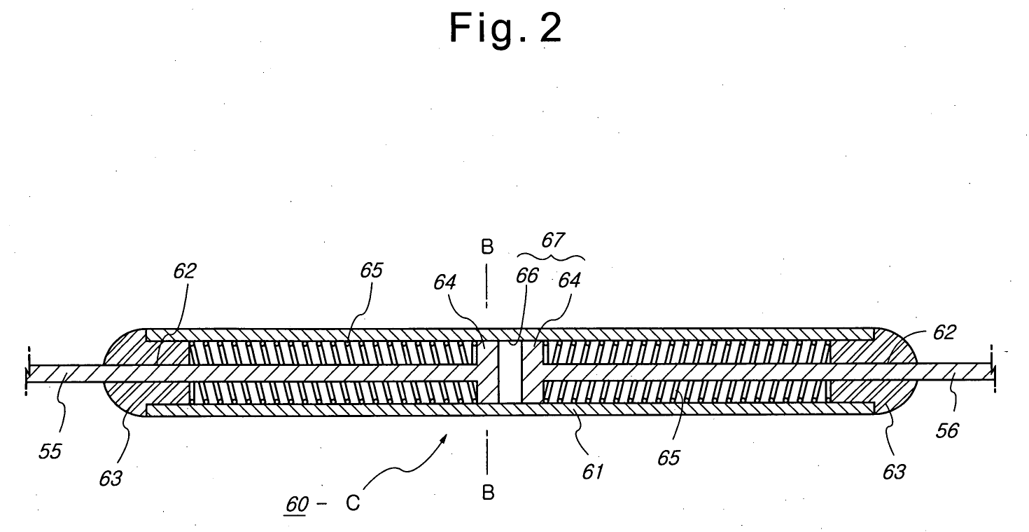

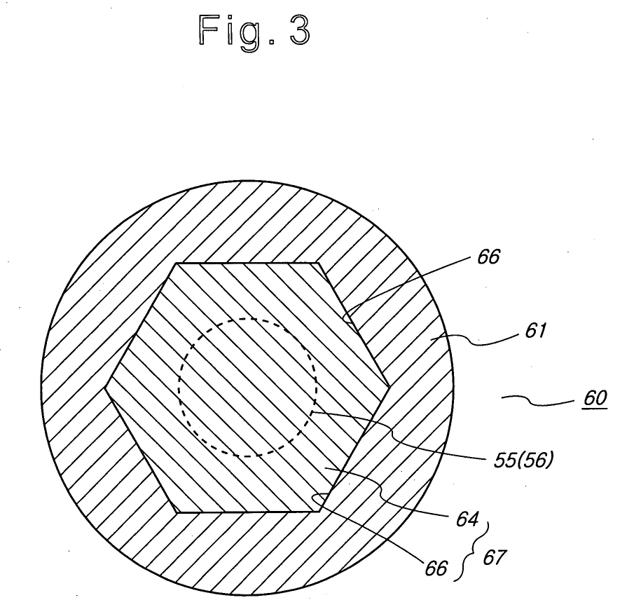

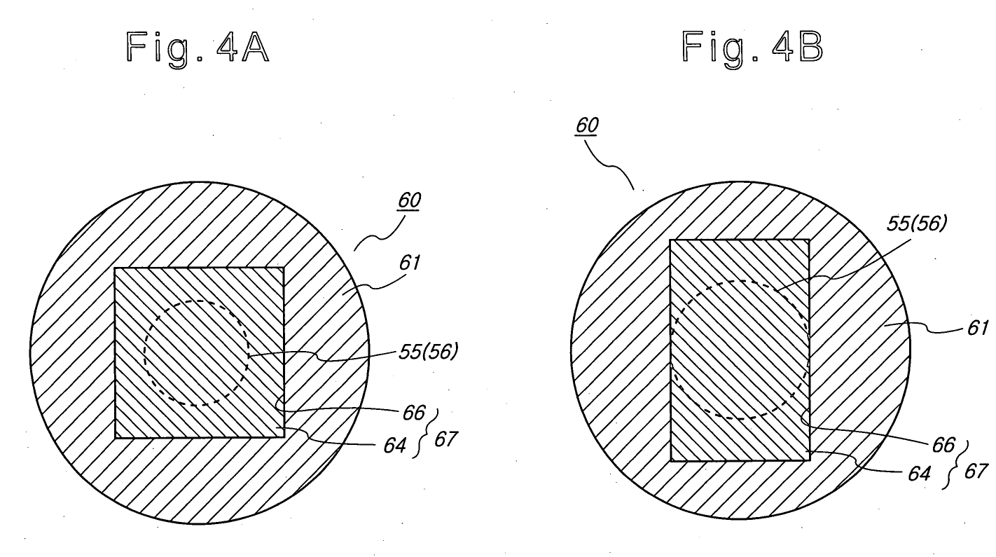

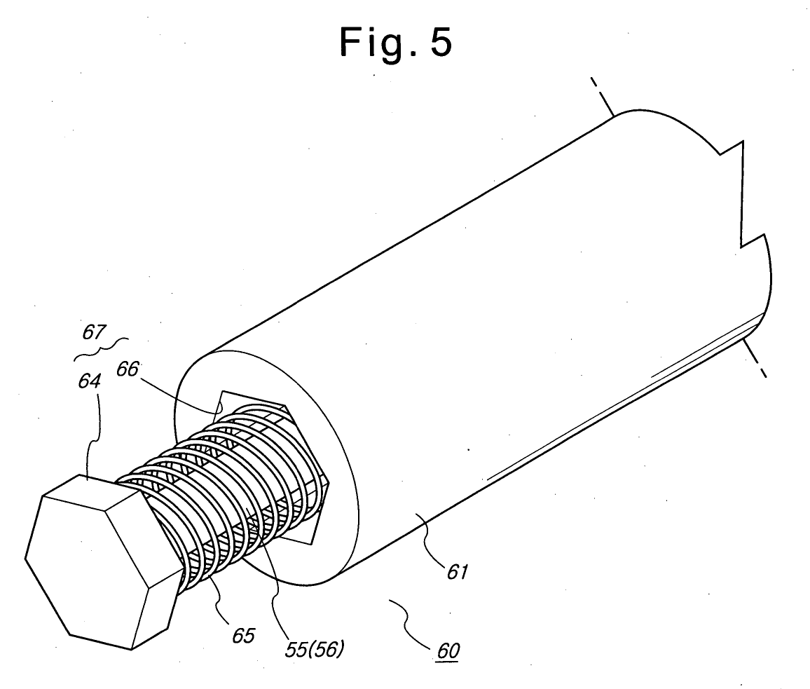

FIG. 1 is a perspective view showing a sunshade clip for spectacles, to which a device for adjusting the length of a sunshade clip for spectacles according to a preferred embodiment of the present invention is applied, FIG. 2 is a longitudinal sectional view of the device for adjusting the length of the sunshade clip for spectacles taken along the line A-A of FIG. 1, FIG. 3 is a cross sectional view of the device for adjusting the length of the sunshade clip for spectacles taken along the line B-B of FIG. 2, FIGS. 4A and 4B are similar to FIG. 3, each of which shows, in cross section, a device for adjusting the length of a sunshade clip for spectacles according to another preferred embodiment of the present invention, and FIG. 5 is an enlarged perspective view, partially broken away, showing the C portion of the device for adjusting the length of the sunshade clip for spectacles of FIG. 2.

A general sunshade clip 50 includes a pair of lens frames 52 and 53 with corresponding colored lenses 51 fitted therein. Each of the lens frames 52 and 53 has prongs 54 formed at the outside thereof, which are vertically spaced apart from each other such that the prongs 54 are fitted around a corresponding frame of spectacles 100.

The lens frames 52 and 53 also have bridge elements 55 and 56, respectively. The bridge elements 55 and 56 are joined to the tops of the frames 52 and 53, respectively, and extended from the tops of the frames 52 and 53, respectively, so that the bridge elements 55 and 56 are connected between the frames 52 and 53. Between the bridge elements 55 and 56 there is mounted a length adjusting device 60 for adjusting the length of the bridge elements 55 and 56.

The length adjusting device 60 includes a cylindrical housing 61 having a length L sufficient for the sunshade clip to be easily engaged with the frames of the spectacles 100 from the outsides of the frames of the spectacles. The housing 61 has an inner wall 66 formed therein. The inner wall 66 extends longitudinally along the housing 61.

To both sides of the housing 61 are attached caps 63 having through-holes 62, through which the bridge elements 55 and 56 are moved in and out, respectively. At the ends of the bridge elements 55 and 56, which are placed inside the housing 61, are formed stoppers 64, respectively.

Between the stoppers and the caps are disposed coil springs 65, respectively, which force the bridge elements 55 and 56 towards each other.

The inner wall 66 of the housing 61 and each stopper 64 together form a rotation preventing unit 67 for preventing rotation of the bridge element 55 or 56 when the bridge element 55 or 56 is moved.

As shown in FIG. 3, the rotation preventing unit 67 formed by the inner wall 66 of the housing 61 and each stopper 64 has a hexagonal section. In other words, not only the inner wall 66 of the housing 61 but also the stoppers 64 have hexagonal sections. Also, the rotation preventing unit 67 formed by the inner wall 66 of the housing 61 and each stopper 64 may have a square or rectangular section as shown in FIG. 4. It should be noted, however, that the section of the rotation preventing unit 67 formed by the inner wall 66 of the housing 61 and each stopper 64 is not limited. For example, the rotation preventing unit 67 formed by the inner wall 66 of the housing 61 and each stopper 64 may have another section, such as a triangular section or a pentagonal section.

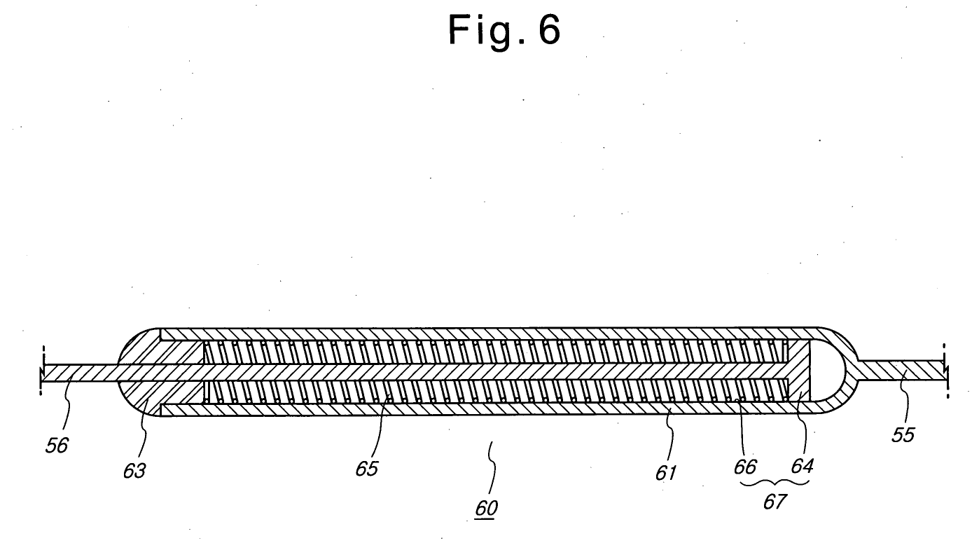

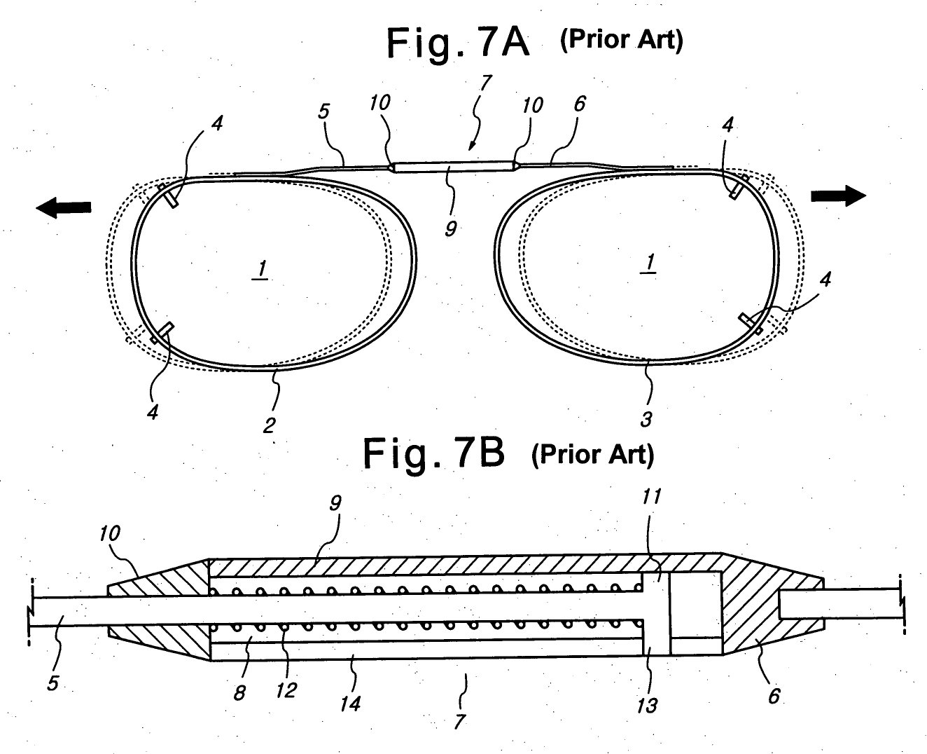

FIG. 6 is a longitudinal sectional view of a device for adjusting the length of a sunshade clip for spectacles according to still another preferred embodiment of the present invention.

As shown in FIG. 6, the device for adjusting the length of the sunshade clip for spectacles according to this embodiment of the present invention is characterized in that one of the bridge elements 55 and 56, i.e., the bridge element 55, is attached to the housing 61, and therefore only the bridge element 56 is movable. It is understood that the device for adjusting the length of the sunshade clip for spectacles according to this embodiment of the present invention has the same effects as the device for adjusting the length of the sunshade clip for spectacles according to the previous embodiment of the present invention.

The operation of the device for adjusting the length of the sunshade clip for spectacles of the present invention will now be described.

When the sunshade clip 50 is to be engaged with the spectacles 100, the frames 52 and 53 of the sunshade clip 50 are pulled in such a manner that the frames 52 and 53 of the sunshade clip 50 are moved away from each other. As a result, the distance between the frames 52 and 53 of the sunshade clip 50 is increased by means of the length adjusting device 60, in which one end of each of the bridge elements 55 and 56 is accommodated. Consequently, the length of the sunshade clip 50 becomes longer than that of the spectacles 100.

Specifically, the bridge elements 55 and 56 inserted in the housing 61 of the length adjusting device 60 are initially arranged in such a manner that the bridge elements 55 and 56 are closest to each other in the middle of the housing 61 by means of the coil springs 65. When the frames 52 and 53 of the sunshade clip 50 are pulled in such a manner that the frames 52 and 53 of the sunshade clip 50 are moved away from each other, the bridge elements 55 and 56 are moved toward both ends of the housing 61 to the maximum against the elastic force of the coil springs 65, whereby the length of the bridge elements 55 and 56 is increased.

After the sunshade clip 50 is engaged with the spectacles under the aforementioned condition, the pulling force on the frames 52 and 53 of the sunshade clip 50 is released. As a result, the sunshade clip 50 is returned to the initial state by means of the restoring force of the coil springs 65 disposed between the caps 63 and the corresponding stoppers 64, respectively.

At this time, the prongs 54 formed at the outsides of the frames 52 and 53 of the sunshade clip 50 are fitted around the frames of the spectacles 100 so that the sunshade clip 50 is securely engaged with the spectacles 100.

It can be seen from the above description that no parts of the length adjusting device 60 are exposed to the exterior of the housing 61 even when the length adjusting device 60 is operated to engage the sunshade clip 50 with the spectacles 100.

Also, the rotation preventing unit 67 formed by the inner wall 66 of the housing 61 and each stopper 64 has any one of different sections for preventing rotation of the bridge element 55 or 56. Consequently, the smooth and easy operation of the length adjusting device 60 is ensured.

As apparent from the above description, the present invention provides a device for adjusting the length of a sunshade clip for spectacles which is capable of preventing not only penetration of moisture and other foreign matters into the device for adjusting the length of a sunshade clip for spectacles but also rotation of bridge elements when the device for adjusting the length of the sunshade clip for spectacles is operated, thereby improving convenience for users and quality of the sunshade clip.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A device for adjusting the length of a sunshade clip for spectacles, the sunshade clip comprising:
a pair of lens frames with corresponding colored lenses fitted therein;
prongs formed at the outside of each frame, the prongs being vertically spaced apart from each other such that the prongs are fitted around a corresponding frame of the spectacles;
bridge elements joined to the tops of the frames and extending from the tops of the frames, respectively, so that the bridge elements are connected between the frames; and
a length adjusting device mounted between the bridge elements for adjusting the length of the bridge elements,
wherein the length adjusting device comprises:
a cylindrical housing with a length sufficient for the sunshade clip to engage with the frames of the spectacles from the outsides of the frames of the spectacles, the housing having a closed inner wall formed in a longitudinal direction for preventing penetration of foreign matters through the inner wall;
caps attached to both sides of the housing, respectively, each of the caps having a through-hole for allowing the corresponding bridge element to move in and out therethrough;
stoppers formed at the ends of the bridge elements, respectively, the stoppers being placed inside the closed inner wall of the housing; and
coil springs disposed between the stoppers and the caps, respectively, for forcing the bridge elements towards each other,
the inner wall of the housing and the stoppers having the same cross section allowing a longitudinal movement of the stoppers within the housing and together forming rotation preventing units for preventing rotation of the bridge elements when the bridge elements are moved.

2. The device as set forth in claim 1, wherein the inner wall of the housing and each of the stoppers placed in the housing have a polygonal cross section.

3. The device as set forth in claim 1, wherein one of the bridge elements is attached to the housing, and the other of the bridge elements is movable.

4. A sunshade clip for mounting on eyeglasses, comprising:
a pair of lens frames with colored lenses fitted therein;
a plurality of prongs formed at the outside of the lens frames, the prongs being spaced apart from one another such that the prongs are fitted around a corresponding lens frame of the eyeglasses;
first and second bridge elements attached at the top of the frames and extending from the top of the frames toward each other; and
a length adjusting device mounted between the first and second bridge elements for adjusting the length of the bridge elements, the length adjusting device including:
a generally cylindrical housing with a length sufficient for the sunshade clip to engage with the frames of the eyeglasses, the housing having a closed side wall extending in a longitudinal direction for preventing penetration of foreign matters through the side wall and first and second ends substantially closed, at least the first end of the housing ends defining a through-hole for allowing at least the first bridge element to move in and out therethrough;
a stopper formed at a free end of the first bridge element, the stopper being placed inside the closed side wall of the housing; and
a coil spring disposed within the housing for biasing the bridge elements towards each other, the side wall of the housing having a polygonal inner cross-section and the stopper having a corresponding polygonal outer cross-section for allowing a longitudinal movement of the stopper within the housing while preventing rotation of the bridge elements with respect to each other.

5. The sunshade clip as set forth in claim 4, wherein the second bridge element is fixed to the second end of the two housing ends.

6. The sunshade clip as set forth in claim 4, wherein the length adjusting device further includes another stopper formed at a free end of the second bridge element for allowing longitudinal movements of the two stoppers within the housing.
